(19) United States
(12) Patent Application Publication
(10) Pub. No.: US 2024/0098510 A1
(43) Pub. Date: Mar. 21, 2024

(54) COMMUNICATION MANAGEMENT SYSTEM, OPERATION MANAGEMENT SYSTEM, AND INTEGRATION SYSTEM

(71) Applicant: NEC Corporation, Tokyo (JP)

(72) Inventor: Yuki Imae, Tokyo (JP)

(73) Assignee: NEC Corporation, Tokyo (JP)

(21) Appl. No.: 18/209,899

(22) Filed: Jun. 14, 2023

(30) Foreign Application Priority Data
Sep. 16, 2022 (JP) 2022-148203

(51) Int. Cl. H04W 16/18

(52) U.S. Cl. CPC H04W 16/18

(57) ABSTRACT

Provided are a communication management system, an operation management system, and an integration system that enable reduction of costs and storage locations required when possession of many mobile base station vehicles is assumed and enable efficient continuation of a mobile communication service even in a case of local traffic increase, temporary traffic increase, and the like. The communication management system includes: a base station operating status storage unit holding operation to information of a base station operated by a communication carrier; a data processing unit selecting a movable object, being equipped with a base station function and managed by a distribution-delivery operator, to be dispatched to a predetermined area, based on positional information and operation plan information of the movable object; and an operation system requesting the distribution-delivery operator to dispatch the selected movable object to the predetermined area, based on a selection result by the data processing unit.

This application is based upon and claims the benefit of priority from Japanese Patent Application No. 2022-148203, filed on Sep. 16, 2022, the disclosure of which is incorporated herein in its entirety by reference.

### TECHNICAL FIELD

The present disclosure relates to a communication management system, an operation management system, and an integration system and particularly relates to a communication management system, an operation management system, and an integration system that are used for placing base stations and providing a communication service.

### BACKGROUND ART

A mobile communication carrier handles cases such as local traffic increase, temporary traffic increase, and a shift of an area in which traffic locally increases in such a way as to be able to continue a communication service. Assuming such an event that traffic becomes unsteady, the mobile communication carrier possesses a mobile base station vehicle. Then, when traffic increase is expected, the communication carrier installs a base station by dispatching the mobile base station vehicle. Examples of local traffic increase and temporary traffic increase include occurrence of a disaster and holding of an event.

The communication carrier can continue the mobile communication service even when traffic locally increases or traffic temporarily increases by functions of a permanently or semipermanently installed base station and functions of a dispatched and installed mobile base station vehicle.

Japanese Unexamined Patent Application Publication No. 2020-113130 (PTL 1) relates to control of a vehicle being capable of autonomous traveling and executing a task. PTL 1 proposes controlling the vehicle in such a way that the vehicle normally executes a task assigned to the vehicle and executes a task different from the aforementioned task in an emergency including a natural disaster such as an earthquake and a tsunami, and a human-made disaster such as a fire and a traffic accident. More specifically, PTL 1 lists provision of a water truck, provision of a water purification vehicle, provision of a mobile base station, and the like as tasks executed by a vehicle capable of automatic driving or unattended driving in an emergency. PTL 1 further describes that such a vehicle is equipped with a module for an emergency and that a vehicle equipped with a mobile base station module can function as a mobile base station.

In PTL 1, a vehicle capable of autonomous traveling normally executes an assigned task and executes a task different from the aforementioned assigned task when an emergency occurs. Thus, a communication carrier does not need to prepare a dedicated vehicle for an emergency and can effectively utilize a vehicle capable of autonomous traveling.

Japanese Unexamined Patent Application Publication No. 2018-056775 (PTL 2) relates to a communication system performing relay with preset fixed base stations and mobile base stations installed on movable objects. PTL 2 proposes configuring a moving-cell base station by equipping a mobile base station device on an automobile (such as a passenger car, a truck, or a bus) being a movable object. PTL 2 proposes that a moving-cell base station performs wireless communication with another base station such as a fixed base station and relays a communication between a user device positioned in a moving cell, and another base station such as a fixed base station. PTL 2 further describes use of the moving-cell base station equipped on an automobile traveling on a mountain trail where radio field intensity from a fixed base station is low. PTL 2 describes that a moving cell is formed around the automobile by the use and that a user along the mountain trail can use a mobile communication service through the moving-cell base station.

PTL 2 further describes that a management device acquires relay communication information of a moving-cell base station equipped on each automobile, compiles the relay communication information in a predetermined period for each automobile owner or each automobile user, and based on the compiled relay communication information, calculates a kickback fee for communication relay at a moving-cell base station for each automobile owner or each automobile user. Then, PTL 2 proposes to promote use of a new communication service through a moving cell by paying the calculated kickback fee to the automobile owner or the automobile user.

Japanese Unexamined Patent Application Publication No. 2017-098797 (PTL 3) relates to control of a plurality of mobile wireless stations. PTL 3 proposes that a central control station moves the position of a mobile wireless station, based on a distribution of wireless terminals positioned around the mobile wireless station and terminal information including a traffic distribution of the wireless terminals. PTL 3 proposes decentralizing traffic by moving a mobile wireless station on which traffic is not concentrated to a spot distant from a mobile wireless station on which traffic is concentrated by a predetermined distance. PTL 3 describes that the above improves throughput of the entire system.

### SUMMARY

When a mobile communication carrier possesses mobile base station vehicles as described above, costs (a purchase cost of the mobile base station vehicles and a management cost) and storage locations are required, which becomes a heavy burden. In particular, when a communication carrier attempts to possess many mobile base station vehicles assuming events that may occur in various aspects in an area where a communication service is provided and events that may occur at the same time in different locations in the area, the aforementioned costs and the aforementioned storage locations are further required, which becomes a heavy burden on the communication carrier. Assuming occurrence of a disaster as an example of a case of local traffic increase and a case of temporary traffic increase, a disaster-stricken area where a disaster is expected to occur is not predetermined. Therefore, there is an issue that when the distance from a storage location of a mobile base station vehicle to a disaster-stricken area is long, the travel time of the mobile base station vehicle becomes long, and therefore it takes time for a communication service to recover. The aforementioned issue of costs and storage locations is remarkable taking into consideration possession of many mobile base station vehicles and placement of many mobile base station vehicles for the purpose of shortening the travel time from a storage location of a mobile base station vehicle to a disaster-stricken area.

When a vehicle capable of autonomous traveling normally executes an assigned task and executes a task different from the aforementioned assigned task when an emergency occurs, as proposed by PTL 1, there is an issue that a dedicated vehicle capable of autonomous traveling needs to be prepared.

When a moving-cell base station is configured by equipping the mobile base station device on an automobile being a movable object, as proposed by PTL 2, the automobile moves in accordance with an intention of the owner or the user of the automobile. Therefore, the automobile equipped with the mobile base station device may not necessarily head for an area where traffic increases and may not necessarily stay in the area where traffic increases in a time period in which traffic increases. Therefore, there is an issue that the proposal in PTL 2 alone may not necessarily be able to handle the case of local traffic increase and the case of temporary traffic increase.

Further, there is an issue that since a truck, a taxi, and the like do not always deliver objects and/or persons, idle time when the vehicle is out of operation occurs, which hinders efficient operation.

Further, since required communication quality is diverse depending on a service content, a traffic condition, and/or the like, a mobile base station vehicle at a location simply close to a destination may not be suitable. There is another issue that operation becomes inefficient when a base station suited for required service quality such as existence of interference with a wireless environment in a surrounding area is not selected.

In view of the aforementioned issues, an object of the present disclosure is to provide a communication management system, an operation management system, and an integration system that enable reduction of costs and storage locations required when possession of many mobile base station vehicles is assumed and enable efficient continuation of a mobile communication service even in a case of local traffic increase, a case of temporary traffic increase, and the like.

In order to achieve the object, a communication management system according to the present disclosure includes:
a base station operating status storage unit holding operation information of a base station operated by a communication carrier providing a mobile communication service;
a data processing unit selecting a movable object to be dispatched to a predetermined area, based on positional information of the movable object, operation plan information of a movable object and equipment information of a base station function equipped on the movable object,
wherein the movable object is managed by a distribution-delivery operator; and an operation system requesting the distribution-delivery operator to dispatch the selected movable object to the predetermined area based on a selection result by the data processing unit.

An operation management system according to the present disclosure includes:
an equipment information storage unit holding equipment information of a movable object being equipped with a base station function for providing a mobile communication service by a communication carrier and being managed by a distribution-delivery operator, wherein the equipment information is information of the base station function equipped on a movable object;
a positional information storage unit holding positional information of the movable object equipped with the base station function;
an operation plan storage unit storing an operation plan of the movable object equipped with the base station function; and
a communication unit giving an instruction to move a requested movable object to a predetermined area in response to a request from a communication carrier providing a mobile communication service.

An integration system according to the present disclosure includes:
the communication management system; and
the operation management system.

### BRIEF DESCRIPTION OF THE DRAWINGS

Exemplary features and advantages of the present disclosure will become apparent from the following detailed description when taken with the accompanying drawings in which:

FIG. 1 is a block diagram for illustrating a communication management system according to a first example embodiment of the present disclosure;

FIG. 2A is a block diagram for illustrating an operation management system according to the first example embodiment of the present disclosure;

FIG. 2B is a configuration diagram for illustrating a mobile base station vehicle managed by the operation management system in FIG. 2A;

FIG. 3 is a block diagram for illustrating an integration system according to the first example embodiment of the present disclosure;

FIG. 4A is a sequence chart for illustrating operation of the integration system in FIG. 3;

FIG. 4B is a sequence chart for illustrating operation of the integration system in FIG. 3;

FIG. 5 is a conceptual diagram for illustrating a relation between a communication carrier and a distribution-delivery operator in the integration system according to the first example embodiment of the present disclosure;

FIG. 6 is a conceptual diagram for illustrating an example of a concept of dispatch and placement of a mobile base station vehicle (selection algorithm example 1) in the integration system according to the first example embodiment of the present disclosure;

FIG. 7 is a table indicating an example of information held by an equipment information storage unit, a positional information storage unit, and an operation plan storage unit in the operation management system in relation to the mobile base station vehicles in FIG. 6;

FIG. 8 is a conceptual diagram for illustrating an example of a concept of dispatch and placement of a mobile base station vehicle (selection algorithm example 2) according to the first example embodiment of the present disclosure;

FIG. 9 is a table indicating an example of information held by the equipment information storage unit, the positional information storage unit, and the operation plan storage unit in the operation management system in relation to mobile base station vehicles in FIG. 8;

FIG. 10 is a conceptual diagram for illustrating an example of a concept of dispatch and placement of a mobile base station vehicle (selection algorithm example 3) according to the first example embodiment of the present disclosure;

FIG. 11 is a table indicating an example of information held by the equipment information storage unit, the positional information storage unit, and the operation plan storage unit in the operation management system in relation to mobile base station vehicles in FIG. 10;

FIG. 12A is a block diagram for illustrating an example of an information processing device providing the communication management system according to the first example embodiment of the present disclosure;

FIG. 12B is a flowchart for illustrating processing performed by the information processing device in FIG. 12A;

FIG. 13A is a block diagram for illustrating an example of an information processing device providing the operation management system according to the first example embodiment of the present disclosure; and

FIG. 13B is a functional block diagram for illustrating processing performed by the information processing device in FIG. 13A.

### EXAMPLE EMBODIMENT

Preferred example embodiments of the present disclosure will be described in detail with reference to drawings.

### (First Example Embodiment)

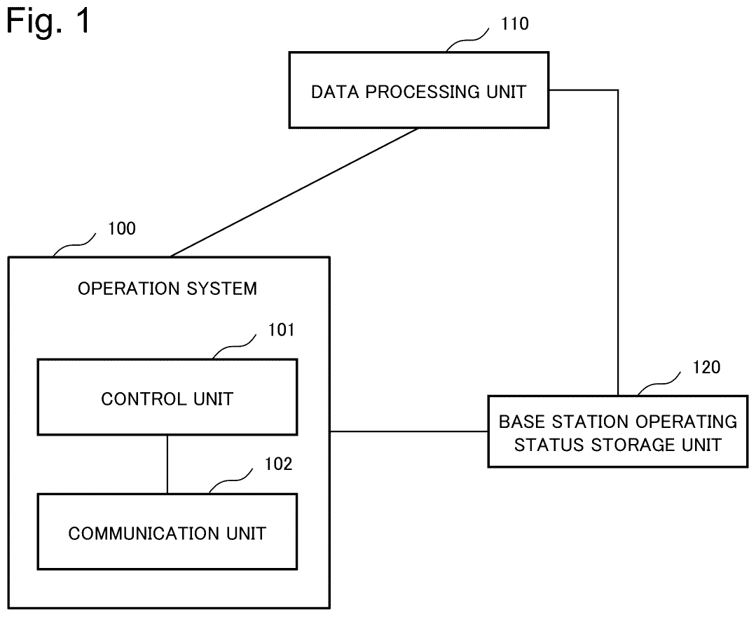

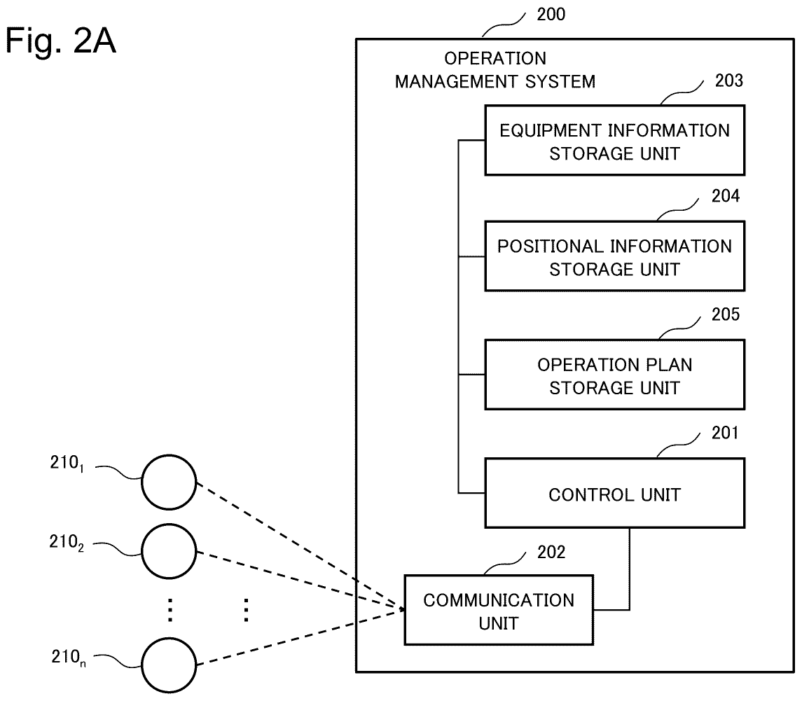

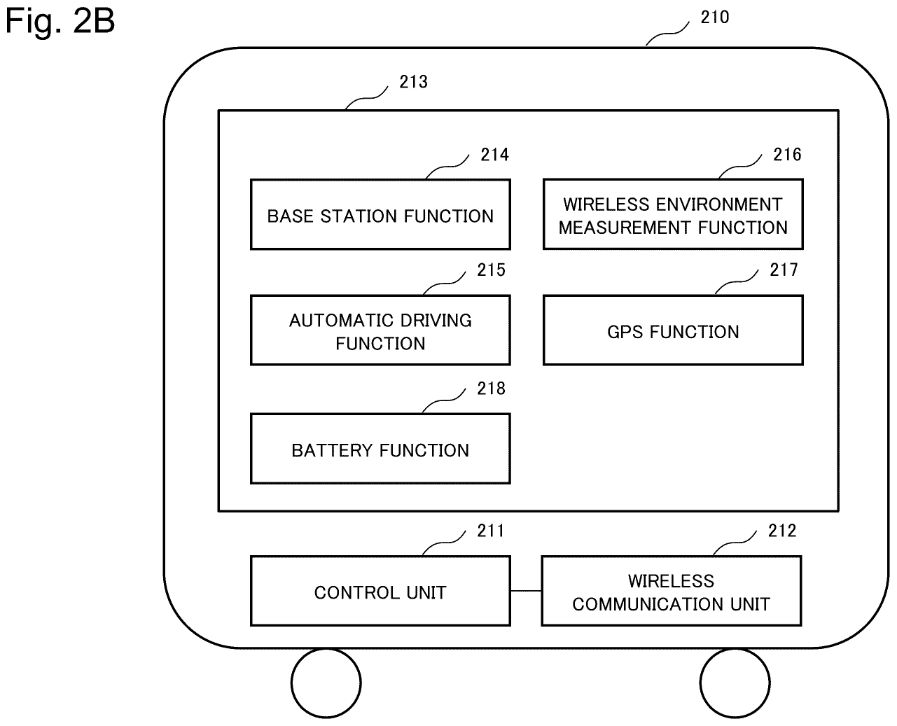

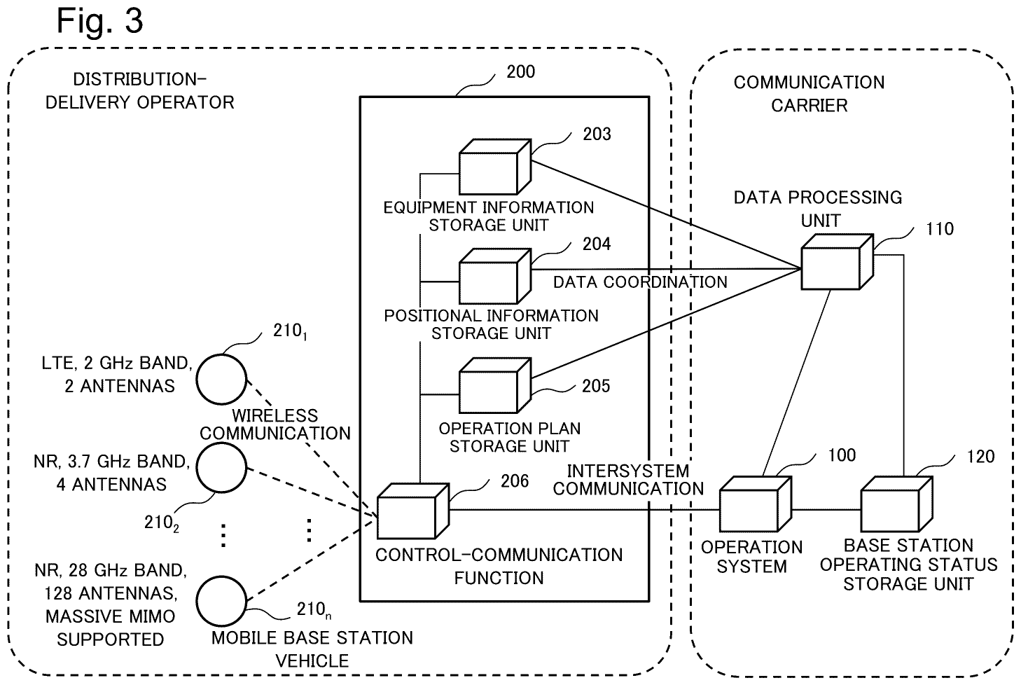

First, a communication management system and the like according to a first example embodiment of the present disclosure will be described. FIG. 1 is a block diagram for illustrating the communication management system according to the first example embodiment of the present disclosure. FIG. 2A is a block diagram for illustrating an operation management system according to the first example embodiment of the present disclosure. FIG. 2B is a configuration diagram for illustrating a mobile base station vehicle managed by the operation management system in FIG. 2A. FIG. 3 is a block diagram for illustrating an integration system according to the first example embodiment of the present disclosure.

### (Configuration)

The integration system according to the present example embodiment includes the communication management system operated and managed by a communication carrier and the operation management system operated and managed by a distribution-delivery operator, as illustrated in FIG. 3. In FIG. 3, an area managed by the communication carrier is enclosed by a dotted line, and an area managed by the distribution-delivery operator is enclosed by a separate dotted line. The operation management system 200 is a system for managing operation of movable objects such as a truck, a bus, a hired car, and a taxi. The movable objects such as a truck, a bus, a hired car, and a taxi are possessed by the distribution-delivery operator or are provided under the control of the distribution-delivery operator.

The communication management system operated and managed by the communication carrier includes an operation system 100, a data processing unit 110, and a base station operating status storage unit 120, as illustrated in FIG. 1 and FIG. 3.

The operation system 100 in the communication management system is managed and operated by the communication carrier. The communication carrier is a communication carrier providing a mobile communication service by placing one or a plurality of base stations. The operation system 100 can perform intersystem communication with the operation management system 200 operated and managed by the distribution-delivery operator and can transmit and receive required information between the systems. The operation system 100 includes a control unit 101 controlling the entire operation system 100 as a whole and a communication unit 102 for communicating with the operation management system 200.

The base station operating status storage unit 120 in the communication management system can store operating status of all base stations possessed by the communication carrier, equipment information of each base station, and information about communication quality of a communication service provided by the base stations. Equipment information and an operating state of a mobile base station vehicle 210 are also stored in the base station operating status storage unit 120 in the communication management system.

Note that “all base stations possessed by the communication carrier” include both all existing base stations operated without change in the installation locations by being installed permanently or semipermanently and all mobile base stations provided by a base station function equipped on a mobile base station vehicle 210 assumed in the example embodiment of the present disclosure. Accordingly, equipment information and operating states of mobile base station vehicles 210 are stored in the base station operating status storage unit 120 as well as equipment information and operating states of all existing base stations.

The data processing unit 110 in the communication management system can refer to data in the base station operating status storage unit 120. Furthermore, the data processing unit 110 provides data coordination with an equipment information storage unit 203, a positional information storage unit 204, and an operation plan storage unit 205 in the operation management system 200 operated and managed by the distribution-delivery operator. The data coordination enables the data processing unit 110 to refer to data in the equipment information storage unit 203, the positional information storage unit 204, and the operation plan storage unit 205 in the operation management system 200. Furthermore, in accordance with an instruction content from the operation system 100, the data processing unit 110 can determine an optimum mobile base station vehicle 210, the installation location of the vehicle, the operating hours of the vehicle, and the like, based on the aforementioned reference data, and notify the determination result to the operation system 100.

The operation management system is operated and managed by the distribution-delivery operator. Mobile base station vehicles 210 (2101 to 210n) are managed and operated by the distribution-delivery operator. Note that n denotes a natural number and is assumed to be related to the number of mobile base station vehicles 210 managed and operated by the distribution-delivery operator or a unique identification number of each mobile base station vehicle 210. Note that n may be 1 or may practically be 2 or greater. It is assumed that a mobile base station vehicle 210 described herein is a movable object, such as a truck, a bus, a hired car, or a taxi, being possessed by the distribution-delivery operator and being equipped with the base station function. It is assumed that equipment related to the base station function is provided or lent to the distribution-delivery operator by the communication carrier. The operation management system 200 includes a control unit 201 controlling the entire operation management system 200, a communication unit 202 communicating with the mobile base station vehicles 210 (2101 to 210n), the equipment information storage unit 203, the positional information storage unit 204, and the operation plan storage unit 205, as illustrated in FIG. 2A. The configuration including the control unit 201 and the communication unit 202 in FIG. 2A is referred to as a control-communication function 206 in FIG. 3.

The operation management system 200 is communicable with each mobile base station vehicle 210 (2101 to 210n) through the communication unit 202 and centrally manages equipment information, positional information, and an operation plan of the mobile base station vehicle 210, and information such as a wireless environment measured by the mobile base station vehicle 210.

An operation plan refers to an operation plan of a truck, a bus, a hired car, a taxi, or the like equipped with the base station function according to the example embodiment of the present disclosure. By reference to an operation plan, the operation management system 200 can recognize an idle time in which a vehicle does not perform a delivery task, a time period in which the vehicle can operate as a base station, a location to be the next destination, and the like.

The equipment information storage unit 203 stores possessed equipment information of every mobile base station vehicle 210 (2101 to 210n).

The positional information storage unit 204 stores positional information of every mobile base station vehicle 210 (2101 to 210n).

The operation plan storage unit 205 stores an operation plan of every mobile base station vehicle 210 (2101 to 210n).

FIG. 2B is a block diagram for illustrating a configuration of the mobile base station vehicle 210 according to the example embodiment. The mobile base station vehicle 210 in FIG. 2B includes a control unit 211, a wireless communication unit 212, and a base station unit. The control unit 211 controls the entire mobile base station vehicle 210 as an existing function of the mobile base station vehicle 210 managed and operated by the distribution-delivery operator. The wireless communication unit 212 communicates with the operation management system 200 for management and operation by the distribution-delivery operator.

Furthermore, the mobile base station vehicle 210 according to the present example embodiment is configured by equipping the base station unit on a movable object possessed by the distribution-delivery operator, such as a truck, a bus, a hired car, or a taxi. The base station unit includes a base station function 214, an automatic driving function 215, a wireless environment measurement function 216, a Global Positioning System (GPS) function 217, a battery function 218, and the like. The base station unit equipped on a movable object is hereinafter referred to as a mobile base station 213.

The base station function 214 in the mobile base station 213 is required for providing a communication service by the communication carrier and it is assumed that equipment related to the base station function 214 is provided or lent to the distribution-delivery operator by the communication carrier. The base station function 214 serves a function equivalent to that of an existing permanently or semipermanently installed base station; and the content of the function is assumed to be that used by the existing base station, and detailed description of the function is omitted.

The automatic driving function 215 in the mobile base station vehicle 210 is a function for automatically moving the mobile base station vehicle 210 to a destination when an installation location of a base station is determined. Equipment of the function also enables unattended operation of the mobile base station vehicle 210.

The GPS function 217 in the mobile base station vehicle 210 is for acquiring positional information of the mobile base station vehicle. The function is for collecting and accumulating information about the current location, a moving history, a moving plan, and the like of the mobile base station vehicle 210.

The wireless environment measurement function 216 in the mobile base station vehicle 210 can measure a wireless environment of the mobile base station vehicle 210. The function enables collection of communication service quality provided by the communication carrier regardless of whether the mobile base station vehicle 210 is moving or at a standstill.

The control unit 211 in the mobile base station vehicle 210 controls the entire mobile base station vehicle 210 as an existing function. The wireless communication unit 212 in the mobile base station vehicle 210 is communicable with the operation management system 200 and transmits information such as positional information of the mobile base station vehicle 210 and a wireless environment measured by the mobile base station vehicle 210 to the operation management system 200.

### (Operation)

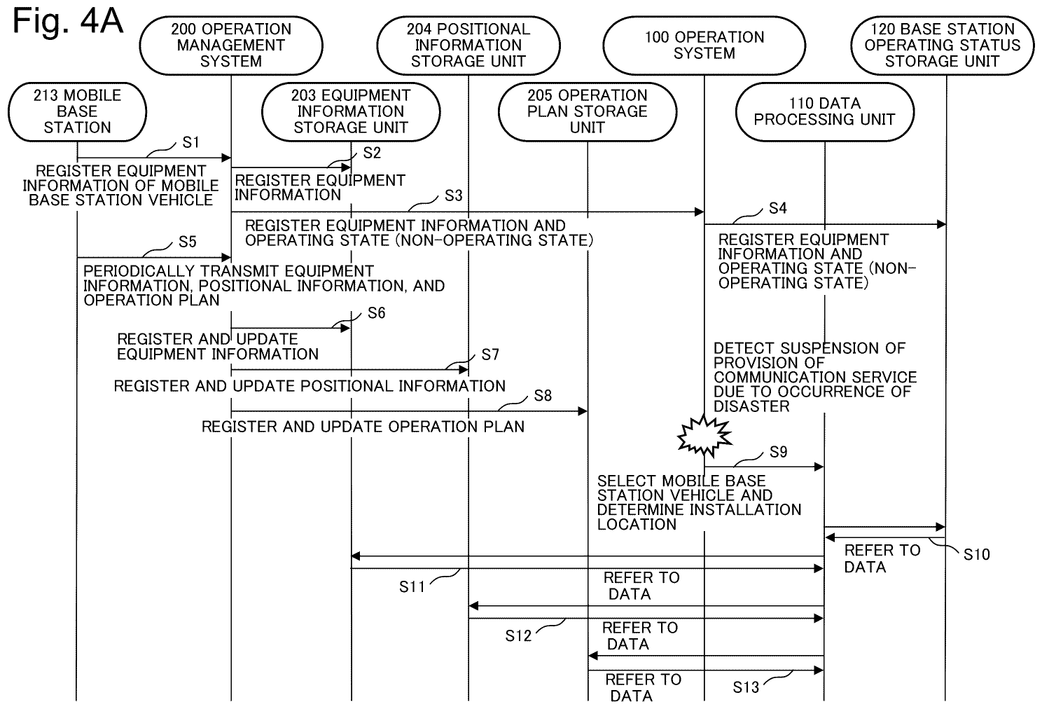

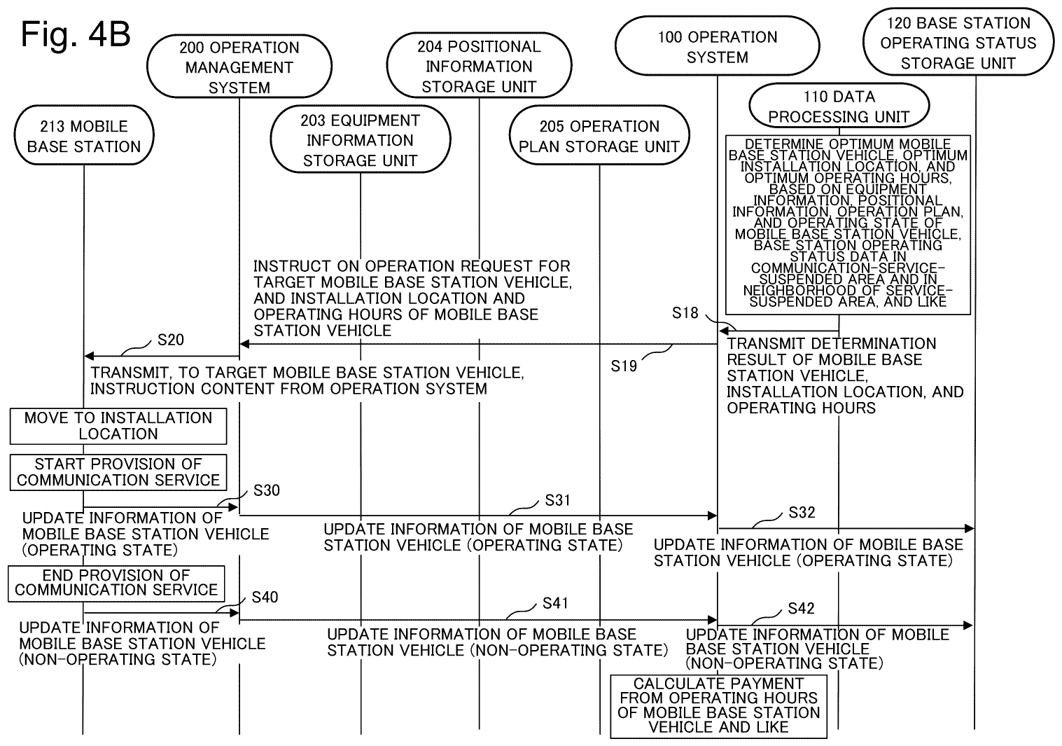

Next, the operation of the communication management system according to the present example embodiment, the operation of the operation management system, and the like will be described. FIG. 4A and FIG. 4B illustrate an operation flow example. It is assumed in FIG. 4A and FIG. 4B that an expression “OPERATING STATE” indicates that the mobile base station 213 is in a state of operating as a base station device, and an expression “NON-OPERATING STATE” indicates that the mobile base station 213 is in a state of not operating as a base station device. In other words, while the mobile base station vehicle 210 (2101 to 210n) is equipped with the base station unit, the base station unit may be in the “OPERATING STATE” or in the “NON-OPERATING STATE.” First, as described in FIG. 4A, each mobile base station 213 transmits equipment information to the operation management system 200 (S1). The equipment information registered in the operation management system 200 is stored in the equipment information storage unit 203 (S2). The equipment information and the operating state of each mobile base station 213 are also registered in the base station operating status storage unit 120 (S3, S4).

Each mobile base station 213 periodically transmits equipment information, positional information, and information about an operation plan to the operation management system 200 (S5).

The equipment information transmitted to the operation management system 200 is stored in the equipment information storage unit 203, and the equipment information in the equipment information storage unit 203 is registered and updated (S6). The equipment information held by the equipment information storage unit 203 is successively updated at each of the aforementioned periodic transmissions. The positional information transmitted to the operation management system 200 is stored in the positional information storage unit 204, and the positional information in the positional information storage unit 204 is registered and updated (S7). The operation plan transmitted to the operation management system 200 is stored in the operation plan storage unit 205, and the operation plan held by the operation plan storage unit 205 is registered and updated at each of the aforementioned periodic transmissions (S8).

For example, when provision of a communication service is suspended in a certain region due to occurrence of a disaster, the operation system 100 detects the suspension of provision of the communication service. Next, the operation system 100 instructs the data processing unit 110 on selection of a mobile base station vehicle and determination of an installation location (S9). At this time, the operation system 100 preferably instructs the data processing unit 110 on selection of a mobile base station vehicle, determination of an installation location, and determination of operating hours. At this time, the operation system 100 may specify, for the data processing unit 110, a cell radius (coverage area) of a mobile base station vehicle and the number of accommodated terminals, and in addition, target communication service quality such as throughput and an interference level.

The data processing unit 110 determines an optimum mobile base station vehicle, an optimum installation location, and optimum operating hours in response to the instruction from the operation system 100 with reference to data in the base station operating status storage unit 120, the equipment information storage unit 203, the positional information storage unit 204, and the operation plan storage unit 205. Specifically, the data processing unit 110 receiving the instruction from the operation system 100 refers to data in the base station operating status storage unit 120 (S10). The data processing unit 110 receiving the instruction from the operation system 100 further refers to data in the equipment information storage unit 203 (S11), refers to data in the positional information storage unit 204 (S12), and refers to data in the operation plan storage unit 205 (S13).

Then, as described in FIG. 4B, the data processing unit 110 determines an optimum mobile base station vehicle, an optimum installation location, and optimum operating hours in response to the instruction from the operation system 100, based on the data collected through the data reference, and the like.

The data processing unit 110 preferably determines an optimum mobile base station vehicle, an optimum installation location, and optimum operating hours, based on the equipment information, the positional information, an operation plan, and the operating state of a mobile base station vehicle, base station operating status data in a communication-service-suspended area and in the neighborhood of the service-suspended area, and the like.

The data processing unit 110 receiving the instruction from the operation system 100 derives an optimum solution including a combination of a plurality of pieces of data. For example, when high throughput is required, the data processing unit 110 selects a mobile base station vehicle possessing equipment with a high frequency bandwidth or equipment supporting multiple input multiple output (MIMO). Further, for example, in order not to adversely affect adjacent cells, the data processing unit 110 selects a mobile base station vehicle possessing equipment with a frequency band enabling avoidance of radio interference with surrounding base stations. Further, for example, the data processing unit 110 derives an optimum solution with respect to a mobile base station vehicle to be dispatched by combining a plurality of pieces of data such as combining the concepts of selection of a mobile base station vehicle.

The information determined by the data processing unit 110 is notified to the operation system 100 (S18). The operation system 100 receiving the notification from the data processing unit 110 instructs the operation management system 200 on an operation request for a target mobile base station vehicle, and an installation location and operating hours of the mobile base station vehicle (S19).

The operation management system 200 transmits, to a target mobile base station vehicle, the instruction content from the operation system 100 (S20).

The mobile base station vehicle receiving the instruction moves in accordance with the instruction content and starts provision of a communication service. When the mobile base station vehicle includes the automatic driving function 215 illustrated in FIG. 2B or the automatic driving function 215 is in an enabled state, automatic driving function 215 automatically moves the mobile base station vehicle to the destination when the installation location of the mobile base station vehicle is determined. The function also enables unattended operation of the mobile base station vehicle. When the mobile base station vehicle does not include the automatic driving function 215 or the automatic driving function 215 is in a disabled state, the mobile base station vehicle moves in accordance with the instruction content from the operation system 100 through driving operation by the driver of the mobile base station vehicle.

When provision of the communication service is started, the target mobile base station 213 is registered in the base station operating status storage unit 120 with status “OPERATING STATE” (S30, S31, S32).

When provision of the communication service ends, the target mobile base station 213 is registered in the base station operating status storage unit 120 with status “NON-OPERATING STATE” (S40, S41, S42).

The mobile base station vehicle may measure a wireless environment during provision of the communication service by the wireless environment measurement function 216 in the vehicle and transmit the measurement result of the wireless environment during provision of the communication service to the base station operating status storage unit 120.

The operation system 100 calculates a payment to the distribution-delivery operator from operating hours of the mobile base station vehicle, and/or the like.

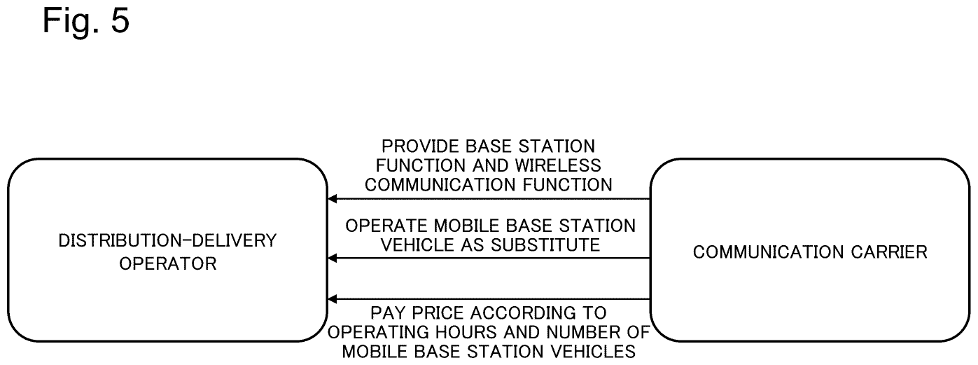

FIG. 5 illustrates a business model example related to the integration system in FIG. 3.

The communication carrier provides or lends the base station function and the wireless communication function to the distribution-delivery operator. The distribution-delivery operator causes trucks, taxis, and/or the like in possession to be able to operate as mobile base station vehicles by equipment of the base station function and the wireless communication function. The distribution-delivery operator operates the mobile base station vehicles as a substitute for the communication carrier. The communication carrier pays the price to the distribution-delivery operator according to operating hours and the number of the mobile base station vehicles. A plurality of selection algorithm examples will be described below with regard to a concept of selection of a mobile base station vehicle by the data processing unit 110 receiving an instruction from the operation system 100.

### <Selection Algorithm Example 1>

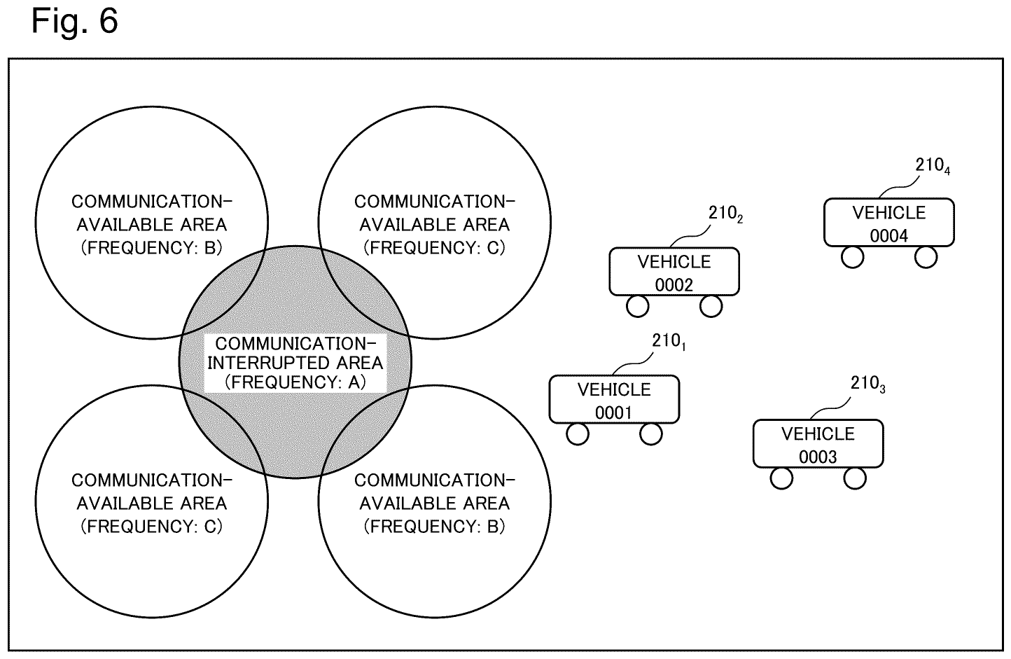

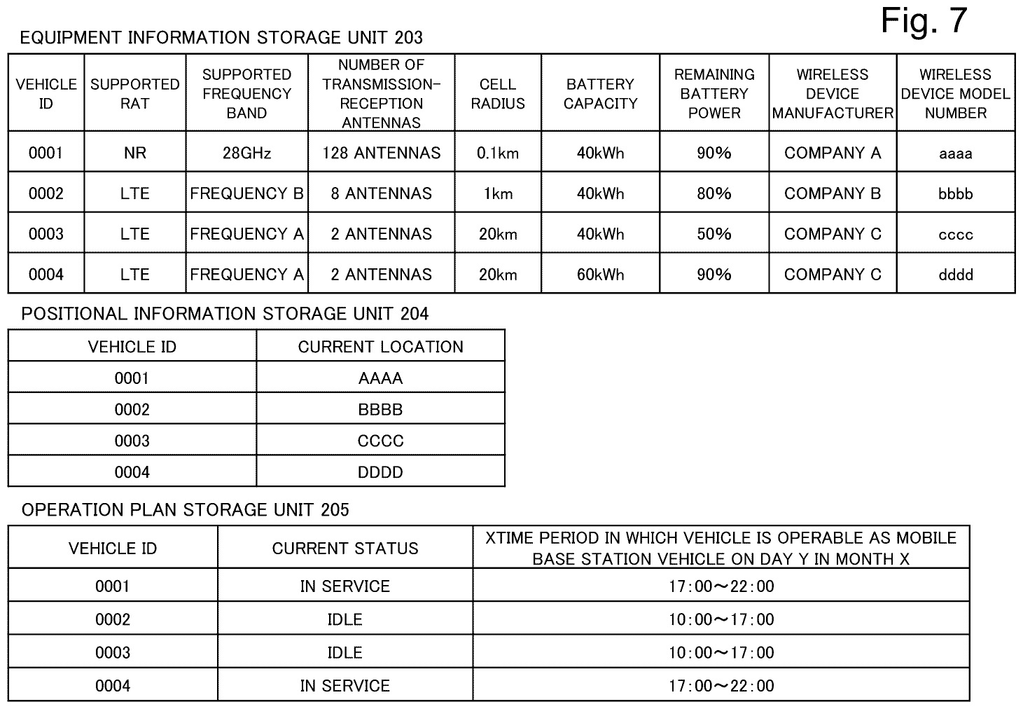

FIG. 6 and FIG. 7 illustrate a selection algorithm example 1 of the data processing unit 110. FIG. 6 is a conceptual diagram for illustrating an example of a concept of dispatch and placement of a mobile base station vehicle (selection algorithm example 1) in the integration system according to the first example embodiment of the present disclosure. FIG. 7 is a table indicating an example of information held by the equipment information storage unit, the positional information storage unit, and the operation plan storage unit in the operation management system in relation to the mobile base station vehicles in FIG. 6. This example is a first example of a concept when a mobile base station vehicle is dispatched and placed on Day Y in Month X.

FIG. 6 illustrates a positional relation between vehicles that may become a mobile base station vehicle and frequencies of a communication-interrupted area to be a destination and cells adjacent to the communication-interrupted area. FIG. 7 indicates information held by the equipment information storage unit 203, the positional information storage unit 204, and the operation plan storage unit 205 in this example.

This example is a case of providing a communication service to an area in which communication is interrupted due to occurrence of a disaster. It is assumed that the starting time of communication interruption due to occurrence of a disaster is 12:00 on Day Y in Month X. FIG. 6 illustrates a case of four communication-available areas existing and an area in which communication is interrupted emerging in between. Specifically, a communication-interrupted area (frequency: A) emerges between an upper-left communication-available area (frequency: B), an upper-right communication-available area (frequency: C), a lower-right communication-available area (frequency: B), and a lower-left communication-available area (frequency: C) on the page.

When communication interruption occurs due to occurrence of a disaster, a factor to take priority is not high throughput but the size of a cell radius (coverage area). Therefore, while a vehicle positioned closest to the area in which communication is interrupted (communication-interrupted area) is a vehicle ID: 0001 (mobile base station vehicle 2101), the vehicle ID: 0001 has the “SUPPORTED FREQUENCY BAND” of 28 GHz and a small cell radius, according to equipment information held by the equipment information storage unit 203, and therefore is not considered a vehicle suited for this case. Further, operation plan information held by the operation plan storage unit 205 tells that the “CURRENT STATUS” of the vehicle ID: 0001 is in service and a “TIME PERIOD IN WHICH VEHICLE IS OPERABLE AS MOBILE BASE STATION VEHICLE ON DAY Y IN MONTH X” is 17:00 to 22:00. Therefore, in consideration of the vehicle being operable as a mobile base station vehicle at and after 17:00, the vehicle ID: 0001 cannot be selected as a mobile base station vehicle.

A vehicle positioned closest to the area in which communication is interrupted next to the vehicle ID: 0001 is a vehicle ID: 0002 (mobile base station vehicle 2102). Operation plan information of the vehicle ID: 0002 held by the operation plan storage unit 205 tells that the “CURRENT STATUS” is idle and a “TIME PERIOD IN WHICH VEHICLE IS OPERABLE AS MOBILE BASE STATION VEHICLE ON DAY Y IN MONTH X” is 10:00 to 17:00, which suggests that the vehicle is in the idle state and is in a time period operable as a mobile base station vehicle and therefore is in an operable state as a mobile base station vehicle. However, according to the equipment information held by the equipment information storage unit 203, the supported frequency band of the vehicle ID: 0002 is the frequency B. The frequency B is a frequency used in adjacent cells (adjacent cells on the upper-left side and the lower-right side on the page in FIG. 6) of the area in which communication is interrupted (communication-interrupted area) and therefore may cause an adverse effect due to interference. Thus, the vehicle may cause an adverse effect due to interference and therefore is not considered a vehicle suited for this case.

A vehicle positioned closest to the area in which communication is interrupted next to the vehicle ID: 0002 is a vehicle ID: 0003 (mobile base station vehicle 2103). The operation plan information held by the operation plan storage unit 205 tells that the “CURRENT STATUS” of the vehicle ID: 0003 (mobile base station vehicle 2103) is idle, and a “TIME PERIOD IN WHICH VEHICLE IS OPERABLE AS MOBILE BASE STATION VEHICLE ON DAY Y IN MONTH X” is 10:00 to 17:00. The equipment information held by the equipment information storage unit 203 tells that the “CELL RADIUS” is 20 km. Thus, the current vehicle ID: 0003 is in the operable state as a mobile base station vehicle, has a large cell radius of 20 km, and has a small interference risk due to supported frequency band being different from those of surrounding cells; and therefore, the vehicle is determined to be a mobile base station vehicle suited for this case. The vehicle ID: 0003 (mobile base station vehicle 2103) thus determined as the mobile base station vehicle suited for this case moves to the communication-interrupted area in FIG. 6 in accordance with the instruction content from the operation management system 200 and starts provision of the communication service.

The vehicle ID: 0003 has a “TIME PERIOD IN WHICH VEHICLE IS OPERABLE AS MOBILE BASE STATION VEHICLE ON DAY Y IN MONTH X” of 10:00 to 17:00 and is operable as a mobile base station vehicle until 17:00; and therefore, when recovery from the communication interruption is not performed by 17:00, the vehicle needs to be replaced by another vehicle. In this case, a vehicle ID: 0004 (mobile base station vehicle 2104) is operable as a mobile base station vehicle at and after 17:00 and has a suitable supported frequency band and a suitable cell radius, and therefore, the vehicle ID: 0004 is selected at and after 17:00. While the “CURRENT STATUS” of the vehicle ID: 0004 is in service, and the vehicle has a “TIME PERIOD IN WHICH VEHICLE IS OPERABLE AS MOBILE BASE STATION VEHICLE ON DAY Y IN MONTH X” of 17:00 to 22:00 and is planned to be out of service at and after 17:00. Further, the vehicle ID: 0004 has a “SUPPORTED FREQUENCY BAND” of the frequency A and a “CELL RADIUS” of 20 km. In other words, when recovery from the communication interruption is not performed by 17:00, the vehicle ID: 0003 is replaced by the vehicle ID: 0004, and the vehicle ID: 0004 operates as a mobile base station vehicle at and after 17:00.

### <Selection Algorithm Example 2>

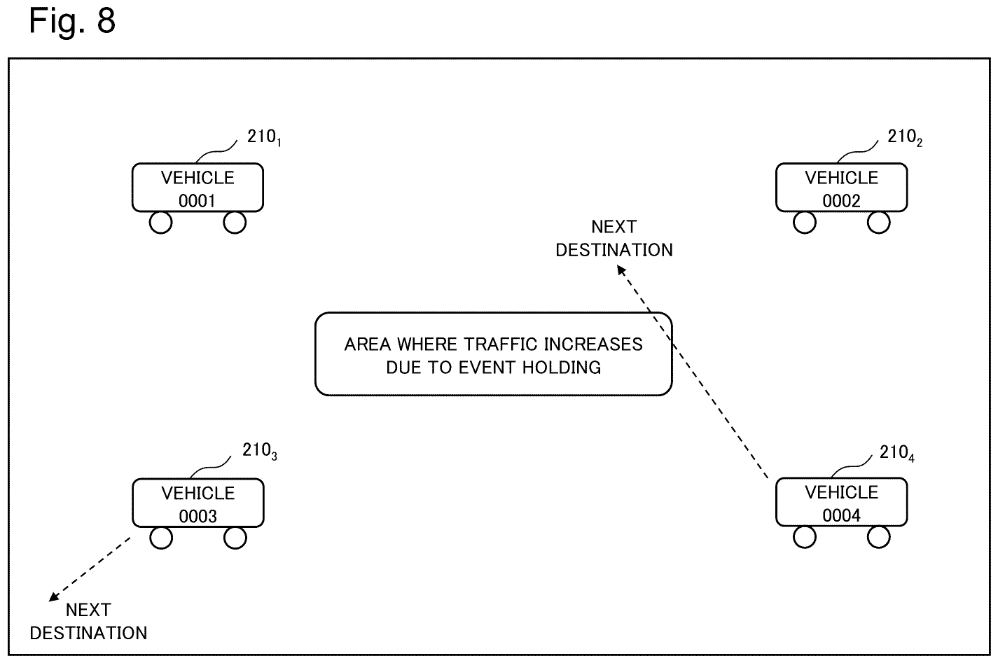

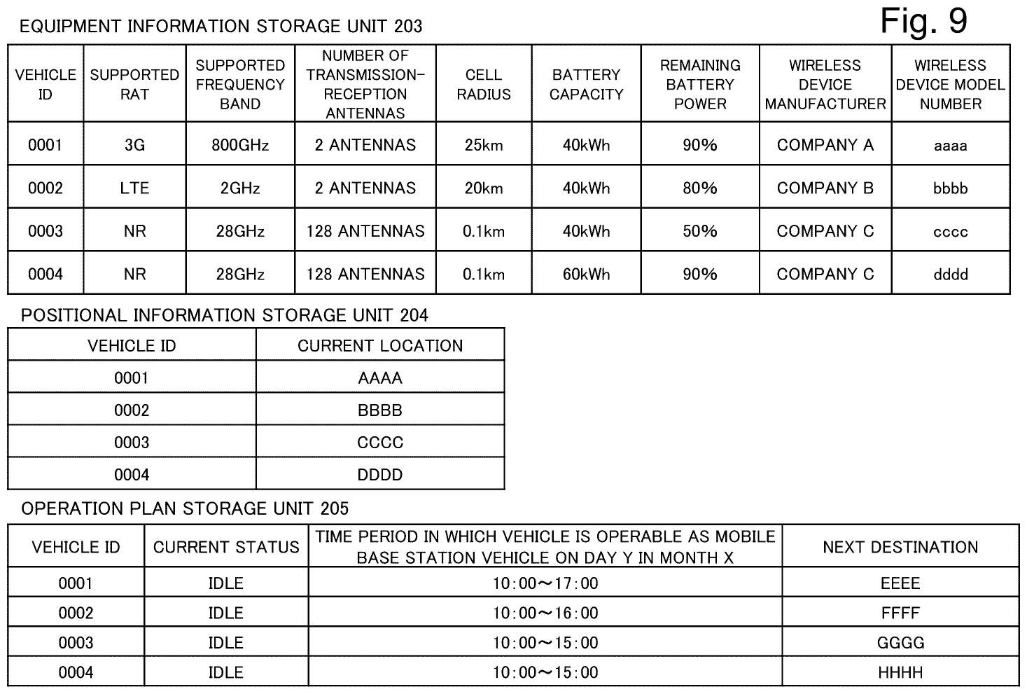

FIG. 8 and FIG. 9 illustrate a selection algorithm example 2 of the data processing unit. FIG. 8 is a conceptual diagram for illustrating an example of a concept of dispatch and placement of a mobile base station vehicle (selection algorithm example 2) in the integration system according to the first example embodiment of the present disclosure. FIG. 9 is a table indicating an example of information held by the equipment information storage unit, the positional information storage unit, and the operation plan storage unit in the operation management system in relation to the mobile base station vehicles in FIG. 8. This example is a second example of a concept when a mobile base station vehicle is dispatched and placed on Day Y in Month X.

FIG. 8 illustrates a positional relation between vehicles that may become a mobile base station vehicle and a traffic increase area to be a destination. FIG. 9 indicates information held by the equipment information storage unit 203, the positional information storage unit 204, and the operation plan storage unit 205 in this example.

This example is a case of providing a communication service to an area where traffic temporarily increases due to event holding. It is assumed in this case that many users play a game requiring high real-time performance on smartphones and that high throughput and low delay are required. It is assumed that a traffic increase time period being a time period in which traffic increase is expected is 12:00 to 15:00 on Day Y in Month X.

A vehicle ID: 0001 (mobile base station vehicle 2101) is in an operable state as a mobile base station vehicle but has only 3G as the “SUPPORTED RADIO ACCESS TECHNOLOGY (RAT)” according to equipment information held by the equipment information storage unit 203 in FIG. 9 and therefore is not suited for this case requiring high throughput and low delay. A vehicle ID: 0002 (mobile base station vehicle 2102) has a “SUPPORTED RAT” of long-term evolution (LTE) and therefore is more suited than the vehicle ID: 0001. However, since a vehicle ID: 0003 (mobile base station vehicle 2103) and a vehicle ID: 0004 (mobile base station vehicle 2104) have a “SUPPORTED RAT” of New Radio (NR), the vehicle ID: 0003 and the vehicle ID: 0004 take priority over the vehicle ID: 0002. One of the vehicle ID: 0003 and the vehicle ID: 0004 is determined as a mobile base station vehicle suited for this case.

Each of the vehicle ID: 0003 and the vehicle ID: 0004 is a vehicle operable as a mobile base station vehicle in the traffic increase time period, supports NR, and therefore is suited for this case requiring high throughput and low delay. In such a case, it is efficient to select a vehicle close to the next destination in the operation plan. In the case illustrated in FIG. 8, the next destination (GGGG) of the vehicle ID: 0003 is in a direction opposite to the traffic increase area, whereas the next destination (HHHH) of the vehicle ID: 0004 is in the same direction as the traffic increase area; and therefore, the vehicle ID: 0004 (mobile base station vehicle 2104) is selected in this case. The thus selected vehicle ID: 0004 (mobile base station vehicle 2104) moves to an area where traffic temporarily increases in a time period in which traffic increase is expected in such a way as to be able to provide a communication service to the area and starts provision of the communication service in such a way as to be in time for the starting time of the traffic increase. Then, the vehicle ID: 0004 (mobile base station vehicle 2104) ends provision of the communication service after the time period in which traffic increase is expected elapses and heads for the next destination.

Assuming that the next destinations of the vehicle ID: 0003 and the vehicle ID: 0004 are the same, a vehicle with greater remaining battery power (vehicle ID: 0004) may be selected. Referring to FIG. 9, the “REMAINING BATTERY POWER” of the vehicle ID: 0003 is 50% (the “BATTERY CAPACITY” is 40 kWh), and the “REMAINING BATTERY POWER” of the vehicle ID: 0004 is 90% (the “BATTERY CAPACITY” is 60 kWh) according to equipment information held by the equipment information storage unit 203. When the next destinations are the same, since the remaining battery power of the vehicle ID: 0004 is greater than the remaining battery power of the vehicle ID: 0003, the vehicle with greater remaining battery power (vehicle ID: 0004) may be selected.

While the vehicle ID: 0004 has been selected in the description above, both the vehicle ID: 0004 and the vehicle ID: 0002 may be selected. By both the vehicle ID: 0004 and the vehicle ID: 0002 operating as mobile base station vehicles in the traffic increase area, dual connectivity by LTE and NR is enabled, and further high-speed communication and traffic distribution are provided. As for whether to select a plurality of vehicles as mobile base station vehicles to be dispatched, the communication carrier may set standards of a threshold value and priority, based on an assumed traffic volume and a communication service quality level the communication carrier prefers to provide.

### <Selection Algorithm Example 3>

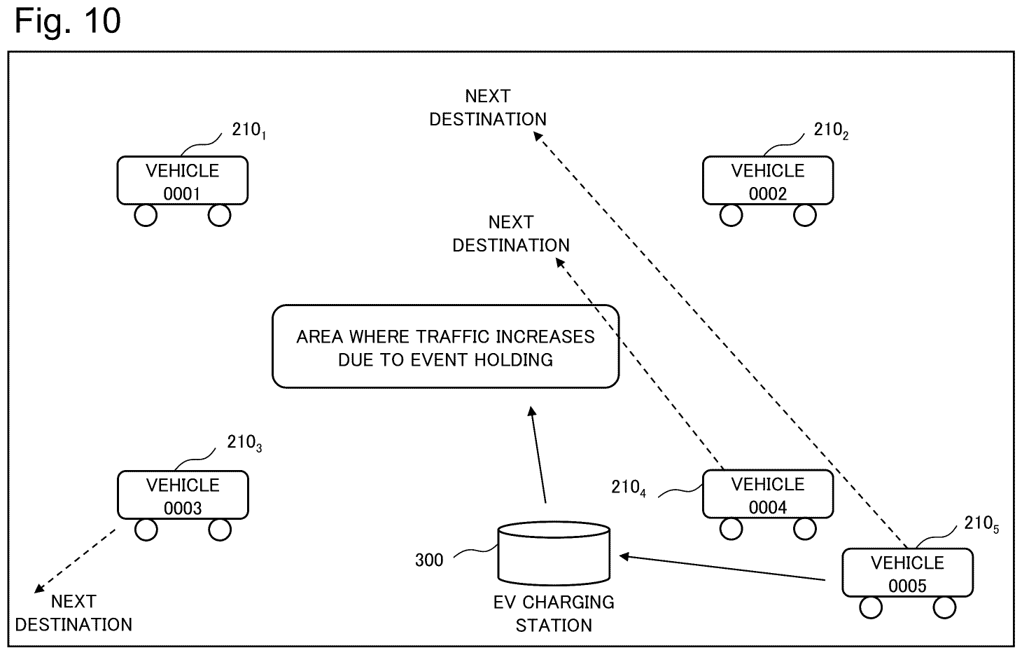

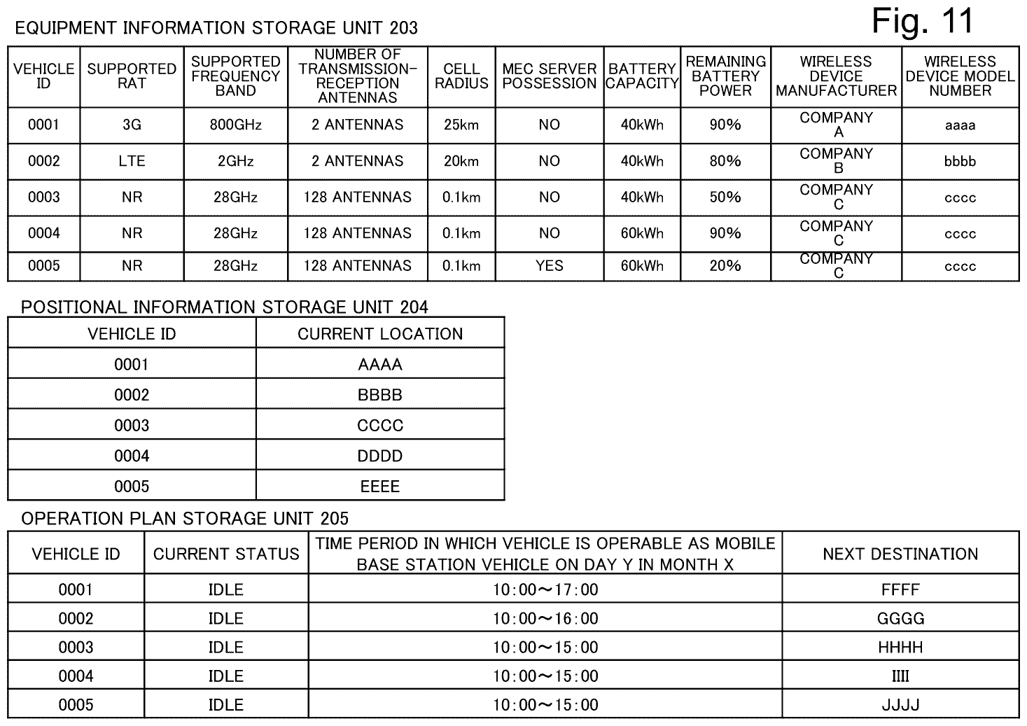

FIG. 10 and FIG. 11 illustrate a selection algorithm example 3 of the data processing unit 110. FIG. 10 is a conceptual diagram for illustrating an example of a concept of dispatch and placement of a mobile base station vehicle (selection algorithm example 3) in the integration system according to the first example embodiment of the present disclosure. FIG. 11 is a table indicating an example of information held by the equipment information storage unit, the positional information storage unit, and the operation plan storage unit in the operation management system in relation to the mobile base station vehicles in FIG. 10. This example is a third example of a concept when a mobile base station vehicle is dispatched and placed on Day Y in Month X.

While this example relates to a concept of dispatch and placement of a mobile base station vehicle to and in an area where traffic increases due to event holding and is a case similar to the selection algorithm example 2 in FIG. 8 and FIG. 9, a vehicle ID: 0005 (2105) is added. Since high throughput and low delay are required in this case, a vehicle possessing a multi-access edge computing server (MEC server) is desirable. Referring to FIG. 11, “MEC SERVER POSSESSION” for a vehicle ID: 0004 is NO, whereas “MEC SERVER POSSESSION” for the vehicle ID: 0005 is YES, according to equipment information held by the equipment information storage unit 203. Thus, comparing the vehicle ID: 0004 with the vehicle ID: 0005, the vehicle ID: 0004 does not possess a MEC server but the vehicle ID: 0005 possesses a MEC server; and therefore, it is desirable to select the vehicle ID: 0005.

However, the vehicle ID: 0005 exists at a position more distant from a traffic increase area in FIG. 10 than the vehicle ID: 0004. Further, referring to FIG. 11, while the vehicle ID: 0004 and the vehicle ID: 0005 have the same “BATTERY CAPACITY” of 60 kWh, the “REMAINING BATTERY POWER” of the vehicle ID: 0004 is 90%, whereas the “REMAINING BATTERY POWER” of the vehicle ID: 0004 is 20%, according to the equipment information held by the equipment information storage unit 203, which makes a difference.

Thus, the vehicle ID: 0005 is positioned more distant from the traffic increase area in FIG. 10 than the vehicle ID: 0004 and has less remaining battery power than the vehicle ID: 0004 in the current status. Therefore, even when the vehicle ID: 0005 moves to the traffic increase area, a continuously operable time in which the vehicle is operable as a mobile base station vehicle is short; and the battery may run out and the communication service may not be provided in the traffic increase time period (12:00 to 15:00 on Day Y in Month X).

In such a case, a time period in which the vehicle ID: 0005 is operable as a mobile base station vehicle, the time required to travel from the current location to the traffic increase area, positional information of a neighboring electric vehicle (EV) charging station, and the like may be referred to, and when a condition that the start time of traffic increase is not missed is confirmed to be met, the vehicle ID: 0005 may be selected in such a way as to move to the traffic increase area via the EV charging station.

The concept of dispatch and placement of a mobile base station vehicle such as the selection algorithm example 3 enables determination of a mobile base station vehicle satisfying the requirement of high throughput and low delay as a base station. Furthermore, the selection algorithm example 3 enables determination of a mobile base station vehicle being suitable to be dispatched considering the distance of the mobile base station vehicle to the traffic increase area and remaining battery power of the mobile base station vehicle.

### (Effects of Example Embodiment)

According to the communication management system according to the present example embodiment, a communication service can be continued by equipping the base station function on a movable object, such as a truck, a bus, a hired car, or a taxi, being possessed by the distribution-delivery operator or being under the control of the distribution-delivery operator and dispatching the movable object. The movable object equipped with the base station function becomes a mobile base station vehicle and can provide the communication service in an area where the vehicle is dispatched.

For example, even when traffic locally increases, traffic temporarily increases, or an area in which traffic locally increases moves, a mobile communication carrier operating and managing the communication management system according to the present example embodiment can continue a communication service by dispatching a movable object being possessed by the distribution-delivery operator or being under the control of the distribution-delivery operator to the relevant area.

When a movable object being possessed by the distribution-delivery operator or being under the control of the distribution-delivery operator is dispatched to the relevant area, one or a plurality of movable objects being possessed by the distribution-delivery operator or being under the control of the distribution-delivery operator can be dispatched.

Criteria for determination of a movable object to be dispatched include the distance of a movable object from the current location to the relevant area, the time required to travel from the current location to the traffic increase area, a route to the relevant area, and the positional information of a neighboring EV charging station. The criteria for determination of a movable object to be dispatched further include the supported RAT, the supported frequency band, the cell radius, and the remaining battery power of the base station function equipped on the movable object. The communication management system can acquire the aforementioned information by referring to data in the equipment information storage unit 203. The criteria for determination of a movable object to be dispatched further include current status such as whether the movable object is in service or idle, a time period in which the movable object is operable as a mobile base station vehicle, and the next destination of the movable object. The communication management system can acquire the aforementioned information by referring to data in the operation plan storage unit 205. The communication management system can determine a movable object to be dispatched in accordance with one of the criteria, a combination of a plurality of the criteria, a plurality of priorities of the criteria, or the like.

According to the communication management system according to the present example embodiment, the communication carrier operating and managing the communication management system does not need to possess many mobile base station vehicles by itself and therefore can reduce costs and storage locations that are required when possession of many mobile base station vehicles is assumed.

Then, in addition to reduction of costs and storage locations that are required when possession of many mobile base station vehicles is to assumed, a mobile communication service can be efficiently continued even in a case of local traffic increase, temporary traffic increase, or the like.

By performing operation of the mobile base station vehicles 210 (2101 to 210n) by the distribution-delivery operator as a substitute, the communication carrier can achieve cost reduction and quality improvement in a communication service. Further, for example, by registering a mobile base station vehicle, a local self-governing body can perform prompt recovery of a communication service for local residents when communication service interruption due to occurrence of a disaster occurs.

Thus, by equipping the base station function on distribution-delivery network equipment such as a truck and a taxi, the equipment can be effectively utilized as mobile base station vehicles 210 (2101 to 210n) in an idle time without a delivery task or a driving task, which widens the business area of the distribution-delivery operator.

Required communication quality is diverse depending on a service content, a traffic condition, and the like; and a base station suited for required service quality such as existence of interference with a wireless environment in a surrounding area can be selected in consideration of the above, as described in the aforementioned selection algorithm example 1 to the selection algorithm example 3. A case of local traffic increase and a case of temporary traffic increase can be handled by selection and dispatch of a mobile base station vehicle 210 by applying one of the techniques described in the aforementioned selection algorithm example 1 to the selection algorithm example 3, or the like. Further, events that may occur in various aspects in an area where a communication service is provided and events that may occur at the same time in different locations in the area can be handled by selection and dispatch of a mobile base station vehicle 210 by applying one of the techniques described in the aforementioned selection algorithm example 1 to the selection algorithm example 3, or the like.

The distribution-delivery operator manages placement of movable objects possessed by the distribution-delivery operator, such as a truck, a bus, a hired car, and a taxi, and an operation plan for transportation, delivery, and the like; and an existing system capable of communication and contact with a driver of a movable object, instruction on a destination to a driver of a movable object, and the like is in operation. When the aforementioned example embodiment is to be implemented, minor changes such as equipping the base station unit on a movable object and adding the equipment information storage unit 203 to the existing system enables implementation of the aforementioned example embodiment. Thus, the distribution-delivery operator can contribute to continuation of a communication service by the mobile communication carrier without the need for a large equipment investment.

### (Second Example Embodiment)

Next, a communication management system and the like according to a second example embodiment of the present disclosure will be described. The present disclosure is not limited to the aforementioned first example embodiment. For example, while equipment information, positional information, and an operation plan are transmitted from the mobile base station vehicle 210 to the operation management system 200, according to the example embodiment in FIG. 3, the mobile base station vehicle 210 may collect and make notification of another piece of information. For example, by transmitting communication quality status such as radio field intensity and an interference level to the operation system 100 through the operation management system 200 by the mobile base station vehicle 210, a communication carrier can recognize an area with poor communication quality and utilize the information for improvement of the communication quality. A business model of paying a price to a distribution-delivery operator by the communication carrier for the communication quality measurement task may be employed.

While a method of using a truck and a taxi as mobile base station vehicles 210 is described in the aforementioned first example embodiment, a vehicle other than a truck and a taxi may be a target of a mobile base station vehicle 210. For example, a method of using a drone, a bus, a railway, and a general passenger car as mobile base station vehicles is feasible. Specifically, use of a movable object as a mobile base station vehicle 210 within the scope of a law and/or an ordinance established in a country or a region in which the example embodiment of the present disclosure is operated may be considered.

While a location where installation of a base station is required is transmitted from the operation system 100 to the mobile base station vehicle 210 in the aforementioned first example embodiment, a method of collecting communication quality status while traveling, autonomously moving to a location with poor communication quality, and providing a communication service by each mobile base station vehicle 210 is also feasible.

While equipment (mobile base station 213) related to the base station function 214 equipped on a truck, a taxi, or the like is provided or lent to the distribution-delivery operator by the communication carrier in the aforementioned first example embodiment, the equipment may be prepared by the distribution-delivery operator.

While a substitute operation method between the communication carrier and the distribution-delivery operator is described in the to aforementioned first example embodiment, a business and/or a self-governing body as well as the communication carrier may utilize a mobile base station vehicle since communication services such as local 5G and private 5G also exist. In other words, a base station device may be equipped on a movable object such as a truck, a bus, a hired car, or a taxi and the movable object may be utilized to configure a mobile base station vehicle according to the aforementioned example embodiment. Movable objects such as a truck, a bus, a hired car, and a taxi are possessed by a business or a self-governing body or are managed by the business or the self-governing body. Accordingly, the example embodiment of the present disclosure may be implemented by reading the aforementioned “distribution-delivery operator” as a business or a self-governing body.

While the communication carrier pays a price according to operating hours and the number of mobile base station vehicles in operation in the business model example in FIG. 5, another payment condition such as paying a price according to the number of work instructions or a work period may be employed. Further, while the base station function and the wireless communication function are provided by the communication carrier in the aforementioned first example embodiment, a method of the functions being provided or lent by a developer-manufacturer of the base station and the wireless communication equipment may also be employed.

Further, selection of a mobile base station vehicle 210, determination of an installation location, and the like that are performed by the data processing unit 110 may be provided as functions of a RAN intelligent controller (RIC). Further, selection results and operation records of mobile base stations may be accumulated, and a selection algorithm of a mobile base station vehicle 210 and a determination algorithm of an installation location may be updated by machine learning.

The factors held by the equipment information storage unit 203, the positional information storage unit 204, and the operation plan storage unit 205 according to the aforementioned first example embodiment are examples and are not limited to the above. While a case of selecting a mobile base station vehicle giving priority to a cell radius (coverage area) and/or the like and a case of selecting a mobile base station vehicle giving priority to high throughput and low-delay performance are described in the selection algorithm examples according to the aforementioned example embodiment, an algorithm of selecting a mobile base station vehicle by combining other factors may be employed. For example, the number of terminals that can be accommodated per cell, massive MIMO support, a continuously operable time as a base station calculated from battery power and remaining battery power, and/or the like may be used.

Further, while the equipment information storage unit 203 stores one RAT and one supported frequency per vehicle in the aforementioned first example embodiment, the present disclosure is not limited to the above. Specifically, one vehicle may possess a plurality of wireless devices, and therefore, a plurality of RATs and a plurality of frequencies may be supported.

While a time period in which a vehicle is operable as a mobile base station vehicle 210 is set to the operation plan storage unit 205 in the aforementioned first example embodiment, it is desirable that the vehicle be able to operate out of the operable time period in an emergency such as occurrence of a disaster. Specifically, it is preferable to separately prepare a normal operation plan and an emergency operation plan assuming a fundamental change in a concept for an operation plan between a normal time and an emergency. Therefore, availability for each use case such as existence of an emergency operation may be set. Further, a business model of setting a price when an emergency operation is performed higher than usual may be employed.

### (Other Example Embodiments)

While the preferred example embodiments of the present disclosure have been described above, the present disclosure is not limited to these example embodiments. For example, the communication management system and the operation management system according to the aforementioned example embodiment may be provided by an information processing device that can execute a program providing the aforementioned operation. The program may be distributed in a form of a computer-readable recording medium. The communication management system according to the aforementioned example embodiment may be provided software-wise by reading the program recorded on such a recording medium and executing the program by the information processing device.

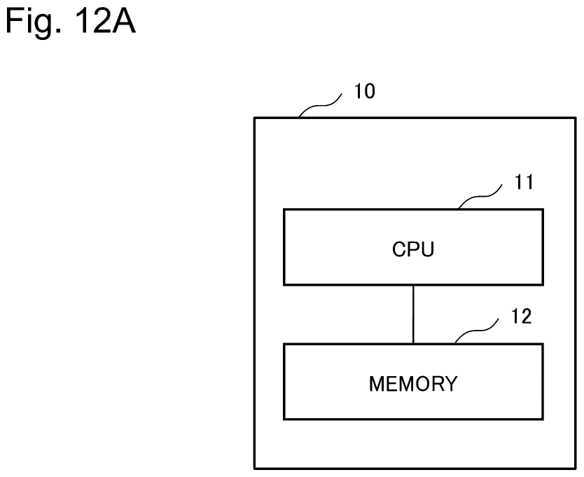

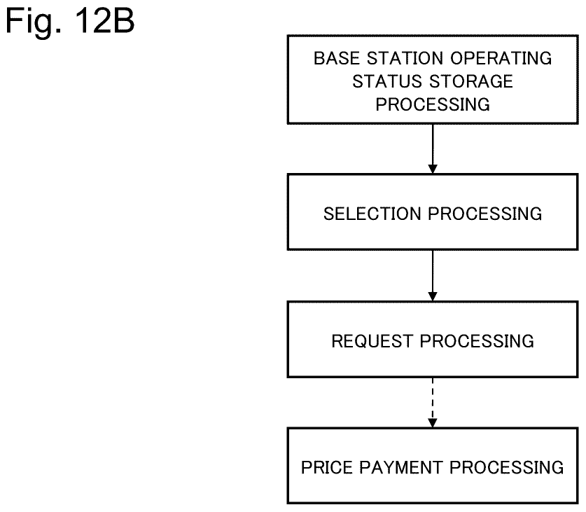

FIG. 12A is a block diagram illustrating an example of an information processing device executing a communication management program according to an example embodiment of the present disclosure. An information processing device 10 in FIG. 12A includes a central processing unit (CPU) 11 and a memory 12 configured with a random-access memory (RAM) and/or the like. For example, the whole or part of base station operating status storage processing, selection processing, request processing, and price payment processing in FIG. 12B may be provided by the information processing device with such a hardware configuration. Specifically, the information processing device 10 in FIG. 12A performs the base station operating status storage processing of holding operation information of a base station operated by a communication carrier providing a mobile communication service. Furthermore, the information processing device 10 in FIG. 12A performs the selection processing of selecting a movable object to be dispatched to a predetermined area, based on positional information and operation plan information of a movable object being equipped with a base station function and being managed by a distribution-delivery operator, and equipment information of the base station function equipped on the movable object. Furthermore, the information processing device 10 in FIG. 12A performs the request processing of requesting the distribution-delivery operator to dispatch the aforementioned selected movable object to the aforementioned predetermined area, based on the selection result in the aforementioned selection processing. Then, the information processing device 10 in FIG. 12A may perform the price payment processing of paying a price to the distribution-delivery operator by the communication carrier according to a dispatch record of a movable object by the distribution-delivery operator, the record being related to the dispatch request of the aforementioned selected movable object to the aforementioned predetermined area. Thus, the communication management system according to the example embodiment of the present disclosure can be provided also by causing the information processing device 10 in FIG. 12A to read and execute the communication management program providing each type of processing in FIG. 12B.

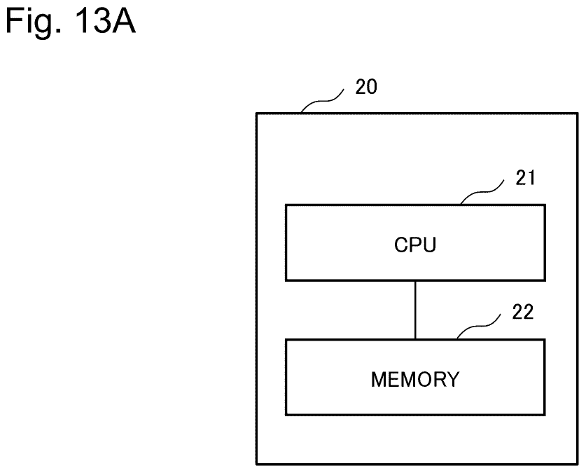

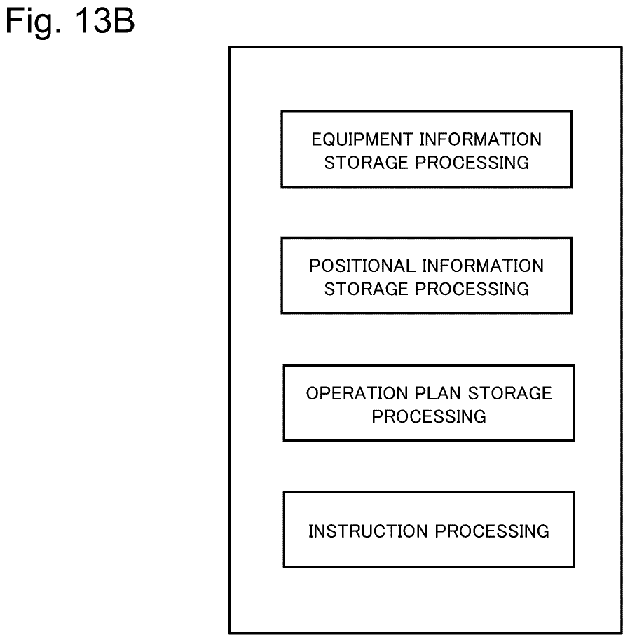

FIG. 13A is a block diagram illustrating an example of an information processing device executing an operation management program according to an example embodiment of the present disclosure. The information processing device 20 in FIG. 13A includes a CPU 21 and a memory 22 configured with a RAM and/or the like. For example, the whole or part of equipment information storage processing, positional information storage processing, operation plan storage processing, and instruction processing in FIG. 13B may be provided by the information processing device 20 with such a hardware configuration. Specifically, the information processing device 20 in FIG. 13A performs the equipment information storage processing of holding equipment information of a movable object being equipped with a base station function for providing a mobile communication service by a communication carrier and being managed by a distribution-delivery operator, particularly equipment information of the base station function equipped on the movable object. Furthermore, the information processing device 20 in FIG. 13A performs the positional information storage processing of holding positional information of a movable object equipped with the base station function. Furthermore, the information processing device 20 in FIG. 13A performs the operation plan storage processing of holding an operation plan of a movable object equipped with the base station function. Furthermore, the information processing device 20 in FIG. 13A performs the instruction processing of, in response to a request from the communication carrier providing a mobile communication service, giving an instruction to move a requested movable object to a predetermined area. Thus, the operation management system according to the example embodiment of the present disclosure can be provided also by causing the information processing device 20 in FIG. 13A to read and execute the operation management program providing each type of processing in FIG. 13B.

Each of the communication management program and the operation management program may be distributed in a form of a recording medium on which the program is recorded. The program may be distributed in a form of a general-purpose semiconductor recording device such as a CompactFlash (registered trademark) (CF) or a Secure Digital (SD), a magnetic recording medium such as a flexible disk, an optical recording medium such as a compact disc read-only memory (CD-ROM), or the like.

As for an operation plan of a movable object by the aforementioned distribution-delivery operator, a plan for transportation, delivery, forwarding, and the like is assumed for a truck and the like, and a plan for hiring, pickup, forwarding, and the like is assumed for a taxi, a hired car, and the like. In selection of a mobile base station vehicle to be dispatched to a traffic increase area, the direct distance between the current location of a mobile base station vehicle and the traffic increase area, the distance (distance following the road) between the current location of the mobile base station vehicle to the traffic increase area, and/or the like is considered. As for an area or a time period in which traffic temporarily increases, a large-scale facility with large capacity and a large number of visitors is assumed, examples of such a facility including a sports field, a stadium, a gymnasium, a theater, a hall, a park, and a recreational facility, and holding of an event is also assumed, examples of such an event including a large-scale event in which many mobile communication users participate and a fireworks display. As for a case of a location of emergence of an area or a time period in which traffic temporarily increases not being previously assumed, for example, a traffic jam, a trouble in a public transportation system, and unexpected concentration of mobile communication users caused by a natural disaster or the like are assumed.

While the disclosure has been particularly shown and described with reference to example embodiments thereof, the disclosure is not limited to these embodiments. It will be understood by those of ordinary skill in the art that various changes in form and details may be made therein without departing from the spirit and scope of the present disclosure as defined by the claims.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

The whole or part of the example embodiments disclosed above can be described as, but not limited to, the following supplementary notes.

### Supplementary Note 1

A communication management system including:
a base station operating status storage unit holding operation information of a base station operated by a communication carrier providing a mobile communication service;
a data processing unit selecting a movable object to be dispatched to a predetermined area, based on positional information and operation plan information of a movable object being equipped with a base station function and being managed by a distribution-delivery operator, and equipment information of a base station function equipped on the movable object; and
an operation system requesting the distribution-delivery operator to dispatch the selected movable object to the predetermined area, based on a selection result by the data processing unit.

### Supplementary Note 2

The communication management system according to Supplementary Note 1, wherein
the base station operating status storage unit holds operation information of a permanently or semipermanently installed base station operated by the communication carrier and operation information of a mobile base station configured by equipping the base station function on the movable object managed by the distribution-delivery operator.

### Supplementary Note 3

The communication management system according to Supplementary Note 1 or 2, wherein,
when selecting a movable object to be dispatched to the predetermined area, the data processing unit refers to one or more items out of a supported radio access technology (supported RAT), a supported frequency band, a cell radius, battery power, remaining battery power, and possession of a multi-access edge computing server (MEC server) of the base station function equipped on the movable object.

### Supplementary Note 4

The communication management system according to Supplementary Note 3, wherein,
when selecting a movable object to be dispatched to the predetermined area, the data processing unit further refers to a current location of the movable object.

### Supplementary Note 5

The communication management system according to Supplementary Note 3, wherein,
when selecting a movable object to be dispatched to the predetermined area, the data processing unit refers to current status indicating either of the movable object being in service and being idle, a time period in which the movable object is operable as a mobile base station, and a next destination of the movable object.

### Supplementary Note 6

The communication management system according to Supplementary Note 1 or 2, wherein
the communication carrier pays a price to the distribution-delivery operator according to a dispatch record of a movable object by the distribution-delivery operator, the record being related to a dispatch request of the selected movable object to the predetermined area.

### Supplementary Note 7

An operation management system including:
an equipment information storage unit holding equipment information of a movable object being equipped with a base station function for providing a mobile communication service by a communication carrier and being managed by a distribution-delivery operator, particularly equipment information of the base station function equipped on a movable object;
a positional information storage unit holding positional information of the movable object equipped with the base station function;
an operation plan storage unit storing an operation plan of the movable object equipped with the base station function; and
a communication unit giving an instruction to move a requested movable object to a predetermined area in response to a request from a communication carrier providing a mobile communication service.

### Supplementary Note 8

The operation management system according to Supplementary Note 7, wherein
the operation management system
   communicates with a movable object managed by the distribution-delivery operator,
   collects positional information of the movable object and updates positional information held by the positional information storage unit, and
   collects an operation plan of the movable object and updates an operation plan held by the operation plan storage unit.

### Supplementary Note 9

The operation management system according to Supplementary Note 7 or 8, wherein
the operation management system
   communicates with a movable object managed by the distribution-delivery operator and
   collects a wireless environment measured by the movable object.

### Supplementary Note 10

An integration system including:
the communication management system according to Supplementary Note 1 or 2; and
the operation management system according to Supplementary Note 7 or 8.

### Supplementary Note 11

A communication management method including:
holding operation information of a base station operated by a communication carrier providing a mobile communication service;
selecting a movable object to be dispatched to a predetermined area, based on positional information and operation plan information of a movable object being equipped with a base station function and being managed by a distribution-delivery operator, and equipment information of a base station function equipped on the movable object; and
requesting the distribution-delivery operator to dispatch the selected movable object to the predetermined area, based on the selection result.

### Supplementary Note 12

The communication management method according to Supplementary Note 11, further including,
in holding of operation information of the base station, holding operation information of a permanently or semipermanently installed base station operated by the communication carrier and operation information of a mobile base station configured by equipping the base station function on the movable object managed by the distribution-delivery operator.

### Supplementary Note 13

The communication management method according to Supplementary Note 11 or 12, further including,
when selecting a movable object to be dispatched to the predetermined area, referring to one or more items out of a supported radio access technology (supported RAT), a supported frequency band, a cell radius, battery power, remaining battery power, and possession of a multi-access edge computing server (MEC server) of the base station function equipped on the movable object.

### Supplementary Note 14

The communication management method according to Supplementary Note 13, further including,
when selecting a movable object to be dispatched to the predetermined area, further referring to a current location of the movable object.

### Supplementary Note 15

The communication management method according to Supplementary Note 13, further including,
when selecting a movable object to be dispatched to the predetermined area, referring to current status indicating either of the movable object being in service and being idle, a time period in which the movable object is operable as a mobile base station, and a next destination of the movable object.

### Supplementary Note 16

The communication management method according to Supplementary Note 11 or 12, wherein
the communication carrier pays a price to the distribution-delivery operator according to a dispatch record of a movable object by the distribution-delivery operator, the record being related to a dispatch request of the selected movable object to the predetermined area.

### Supplementary Note 17

A communication management program causing a computer to execute:
base station operating status storage processing of holding operation information of a base station operated by a communication carrier providing a mobile communication service;
selection processing of selecting a movable object to be dispatched to a predetermined area, based on positional information and operation plan information of a movable object being equipped with a base station function and being managed by a distribution-delivery operator, and equipment information of a base station function equipped on the movable to object; and
request processing of requesting the distribution-delivery operator to dispatch the selected movable object to the predetermined area, based on a selection result in the selection processing.

### Supplementary Note 18

The communication management program according to Supplementary Note 17, wherein,
in the base station operating status storage processing, operation information of a permanently or semipermanently installed base station operated by the communication carrier and operation information of a mobile base station configured by equipping the base station function on the movable object managed by the distribution-delivery operator are held.

### Supplementary Note 19

The communication management program according to Supplementary Note 17 or 18, wherein,
in the selection processing of selecting a movable object to be dispatched to the predetermined area, one or more items out of a supported radio access technology (supported RAT), a supported frequency band, a cell radius, battery power, remaining battery power, and possession of a multi-access edge computing server (MEC server) of the base station function equipped on the movable object are referred to.

### Supplementary Note 20

The communication management program according to Supplementary Note 19, wherein,
in the selection processing of selecting a movable object to be dispatched to the predetermined area, a current location of the movable object is further referred to.

### Supplementary Note 21

The communication management program according to Supplementary Note 19, wherein,
in the selection processing of selecting a movable object to be dispatched to the predetermined area, current status indicating either of the movable object being in service and being idle, a time period in which the movable object is operable as a mobile base station, and a next destination of the movable object are referred to.

### Supplementary Note 22

The communication management program according to Supplementary Note 17 or 18, further causing the computer to execute
price payment processing of the communication carrier paying a price to the distribution-delivery operator according to a dispatch record of a movable object by the distribution-delivery operator, the record being related to a dispatch request of the selected movable object to the predetermined area.

### Supplementary Note 23

An operation management method including:
holding equipment information of a movable object being equipped with a base station function for providing a mobile communication service by a communication carrier and being managed by a distribution-delivery operator, particularly equipment information of the base station function equipped on a movable object;
holding positional information of the movable object equipped with the base station function;
storing an operation plan of the movable object equipped with the base station function; and
giving an instruction to move a requested movable object to a predetermined area in response to a request from a communication carrier providing a mobile communication service.

### Supplementary Note 24

The operation management method according to Supplementary Note 23, further including:
communicating with a movable object managed by the distribution-delivery operator;
collecting positional information of the movable object and updating the held positional information; and
collecting an operation plan of the movable object and updating the held operation plan.

### Supplementary Note 25

The operation management method according to Supplementary Note 23 or 24, further including:
communicating with a movable object managed by the distribution-delivery operator; and
collecting a wireless environment measured by the movable object.

### Supplementary Note 26

An operation management program causing a computer to execute:
equipment information storage processing of holding equipment information of a movable object being equipped with a base station function for providing a mobile communication service by a communication carrier and being managed by a distribution-delivery operator, particularly equipment information of the base station function equipped on a movable object;
positional information storage processing of holding positional information of the movable object equipped with the base station function;
operation plan storage processing of storing an operation plan of the movable object equipped with the base station function; and
instruction processing of giving an instruction to move a requested movable object to a predetermined area in response to a request from a communication carrier providing a mobile communication service.

### Supplementary Note 27

The operation management program according to Supplementary Note 26, further causing the computer to execute:
communication with a movable object managed by the distribution-delivery operator;
collection of positional information of the movable object and update of positional information held in the positional information storage processing; and
collection of an operation plan of the movable object and update of an operation plan held in the operation plan storage processing.

### Supplementary Note 28

The operation management program according to Supplementary Note 26 or 27, further causing the computer to execute:
communication with a movable object managed by the distribution-delivery operator; and
collection of a wireless environment measured by the movable object.

1. A communication management system comprising:
a base station operating status storage unit holding operation information of a base station operated by a communication carrier providing a mobile communication service;
a data processing unit selecting a movable object to be dispatched to a predetermined area, based on positional information of the movable object, operation plan information of the movable object and equipment information of a base station function equipped on the movable object
wherein the movable object is managed by a distribution-delivery operator; and
an operation system requesting the distribution-delivery operator to dispatch the selected movable object to the predetermined area based on a selection result by the data processing unit.

2. The communication management system according to claim 1, wherein the base station operating status storage unit holds operation information of a permanently or semipermanently installed base station operated by the communication carrier and operation information of a mobile base station configured by equipping the base station function on the movable object managed by the distribution-delivery operator.

3. The communication management system according to claim 1, wherein,
when selecting a movable object to be dispatched to the predetermined area, the data processing unit refers to one or more items out of a supported radio access technology (supported RAT), a supported frequency band, a cell radius, battery capacity, remaining battery power, and possession of a multi-access edge computing server (MEC server) of the base station function equipped on the movable object.

4. The communication management system according to claim 2, wherein,
when selecting a movable object to be dispatched to the predetermined area, the data processing unit refers to one or more items out of a supported radio access technology (supported RAT), a supported frequency band, a cell radius, battery capacity, remaining battery power, and possession of a multi-access edge computing server (MEC server) of the base station function equipped on the movable object.

5. The communication management system according to claim 3, wherein,
when selecting a movable object to be dispatched to the predetermined area, the data processing unit further refers to a current location of the movable object.

6. The communication management system according to claim 4, wherein,
when selecting a movable object to be dispatched to the predetermined area, the data processing unit further refers to a current location of the movable object.

7. The communication management system according to claim 3, wherein,
when selecting a movable object to be dispatched to the predetermined area, the data processing unit refers to current status indicating either of the movable object being in service and being idle, a time period in which the movable object is operable as a mobile base station, and a next destination of the movable object.

8. The communication management system according to claim 4, wherein,
when selecting a movable object to be dispatched to the predetermined area, the data processing unit refers to current status indicating either of the movable object being in service and being idle, a time period in which the movable object is operable as a mobile base station, and a next destination of the movable object.

9. The communication management system according to claim 1, wherein the communication carrier pays a price to the distribution-delivery operator according to a dispatch record of a movable object by the distribution-delivery operator who respond to a dispatch request of the selected movable object to the predetermined area.

10. The communication management system according to claim 2, wherein
the communication carrier pays a price to the distribution-delivery operator according to a dispatch record of a movable object by the distribution-delivery operator who respond to a dispatch request of the selected movable object to the predetermined area.

11. An operation management system comprising:
an equipment information storage unit holding equipment information of a movable object being equipped with a base station function for providing a mobile communication service by a communication carrier and being managed by a distribution-delivery operator,
wherein the equipment information is information of the base station function equipped on the movable object;
a positional information storage unit holding positional information of the movable object equipped with the base station function;
an operation plan storage unit storing an operation plan of the to movable object equipped with the base station function; and
a communication unit giving an instruction to move a requested movable object to a predetermined area in response to a request from a communication carrier providing a mobile communication service.

12. The operation management system according to claim 11, wherein
the operation management system
communicates with a movable object managed by the distribution-delivery operator,
collects positional information of the movable object and updates positional information held by the positional information storage unit, and
collects an operation plan of the movable object and updates an operation plan held by the operation plan storage unit.

13. The operation management system according to claim 11,
wherein the operation management system
communicates with a movable object managed by the distribution-delivery operator and
collects a wireless environment measured by the movable object.

14. The operation management system according to claim 12, wherein
the operation management system
communicates with a movable object managed by the distribution-delivery operator and
collects a wireless environment measured by the movable to object.

15. An integration system comprising:
a communication management system; and
an operation management system,
wherein
the communication management system comprising:
a base station operating status storage unit holding operation information of a base station operated by a communication carrier providing a mobile communication service;
a data processing unit selecting a movable object to be dispatched to a predetermined area, based on positional information of the movable object, operation plan information of the movable object and equipment information of a base station function equipped on the movable object
wherein the movable object is managed by a distribution-delivery operator; and
an operation system requesting the distribution-delivery operator to dispatch the selected movable object to the predetermined area based on a selection result by the data processing unit, and
the operation management system comprising:
an equipment information storage unit holding equipment information of a movable object being equipped with a base station function for providing a mobile communication service by a communication carrier and being managed by a distribution-delivery operator,
wherein the equipment information is information of the base station function equipped on the movable object;
a positional information storage unit holding positional information of the movable object equipped with the base station function;
an operation plan storage unit storing an operation plan of the movable object equipped with the base station function; and
a communication unit giving an instruction to move a requested movable object to a predetermined area in response to a request from a communication carrier providing a mobile communication service.

16. An integration system according to claim 15,
wherein the operation management system
communicates with a movable object managed by the distribution-delivery operator,
collects positional information of the movable object and updates positional information held by the positional information storage unit, and
collects an operation plan of the movable object and updates an operation plan held by the operation plan storage unit.

17. An integration system according to claim 15,
wherein the base station operating status storage unit holds operation information of a permanently or semipermanently installed base station operated by the communication carrier and operation information of a mobile base station configured by equipping the base station function on the movable object managed by the distribution-delivery operator.

18. An integration system according to claim 16,
wherein the base station operating status storage unit holds operation information of a permanently or semipermanently installed base station operated by the communication carrier and operation information of a mobile base station configured by equipping the base station function on the movable object managed by the distribution-delivery operator.
